(19) United States
(12) Patent Application Publication
(10) Pub. No.: US 2011/0301937 A1
(43) Pub. Date: Dec. 8, 2011

(54) ELECTRONIC READING DEVICE

(75) Inventors: TZU-MING WANG, Kaohsiung County (TW); KAI-CHENG CHUANG, Tainan City (TW)

(73) Assignee: E INK HOLDINGS INC., Hinchu City (TW)

(21) Appl. No.: 13/034,343

(22) Filed: Feb. 24, 2011

(30) Foreign Application Priority Data
Jun. 2, 2010 (TW) 099117843

(51) Int. Cl. G10L 21/06; G06F 17/28

(52) U.S. Cl. 704/3; 704/235; 704/E21.019

(57) ABSTRACT

The present invention provides an electronic reading device. At the device, a voice is captured by a capturing unit, and then the reference information stored in a storing unit is received by a processing unit for converting the voice to a visual image signal based on the reference information. Afterwards, the visual image corresponding to the visual image signal is shown on a display unit. Therefore, the device provides the function of speech recognition anywhere and anytime and is suitable for prolonged use due to the features of power saving and easy reading.

The application claims the benefit of Taiwan Patent Application No. 099117843, filed on Jun. 2, 2010, in the Taiwan Intellectual Property Office, the disclosures of which are incorporated herein in their entirety by reference.

### FIELD OF THE INVENTION

The invention is related to an electronic reading device, more particularly to an electronic reading device with speech recognition and language translation.

### BACKGROUND OF THE INVENTION

The touch input method is gradually substituted for the keyboard input method and configured in the current electronic devices. However, with researches and developments of the speech recognition, the users can directly send a command to the electronic device through spoken words and active the electronic device to perform the operations corresponding to the command. Thus, a new epoch of the speech recognition gradually approaches.

For the speech recognition technique, since the command can be input promptly, users who are not familiar with the keyboard input method can also easily give computer with a command. Therefore, speech recognition is gradually applied on the electronic device, such as: the computer, the smart phone with voice-activated dialing, and a voice remote control system, etc. However, the speech recognition of the current electronic devices is not suitable for prolonged or exhaustive usage. The reasons are that for example, the power consumption of the display on the cell phone is huge so that the speech recognition thereof is distributed with less power and is accordingly not suitable for prolonged use. In addition, the cell phone is not suitable for prolonged reading because of the screen reflection problem and the small reading area available on the screen. Therefore, the speech recognition is only used to perform the voice-activated dialing in the cell phone.

Furthermore, people with hearing impairment usually communicate with each other in sign language since they can not hear the ambient sound very clearly. However, there is quite a minority of people who know sign language. People with hearing impairment can only communicate with normal people by gesture to do a simple conversation. Similarly, if one enters a foreign country, where he/she is not familiar with the language thereof, he/she can not understand the speeches in surroundings although he/she can hear the ambient sound. At that time, he/she can not understand spoken words by hearing so that he/she is like a person with hearing impairment.

Therefore, to overcome the drawbacks from the prior art and to meet the present needs, the Applicant dedicated in considerable experimentation and research, and finally accomplished the “electronic reading device” of the present invention to provide an electronic reading device with speech recognition. Due to the features of power saving and environmental consciousness so as, the device can provides the function of speech recognition anywhere and anytime and is suitable for prolonged use. The present invention is briefly described as follows.

### SUMMARY OF THE INVENTION

To solve the above drawbacks, the present invention provides a device with speech recognition based on concepts of power saving and environmental consciousness so as to provide a user to simply utilize speech recognition and read the recorded contents anywhere and any time for broadening the scope of the applications of speech recognition.

The present invention also provides a device to assist people with hearing impairment to know the contents of the communications in all situations and to assist normal people traveling in a foreign country encountering with a language barrier to know the contents of the communications.

According to the first aspect of the present invention, an electronic reading device is, provided. The electronic reading device includes a capturing unit capturing a voice; a first storage unit storing reference information; and a processing unit converting the voice to a visual image signal based on the reference information.

Preferably, the electronic reading, device further includes a display unit showing a visual image corresponding to the visual image signal; and a second storage unit storing at least one of the visual image signal and the voice.

Preferably, the display unit includes a bistable display.

Preferably, the bistable display is one selected from a group consisting of an electrophoretic display, a cholesteric liquid crystal display and a quick-response liquid powder display.

Preferably, the visual image is one selected from a group consisting of a word image, a figure image, a symbol image and a combination thereof.

Preferably, the visual image signal is one selected from a group consisting of a word signal, a figure signal, a symbol signal and a combination thereof.

Preferably, the reference information includes speech recognition information provided to the processing unit for converting the voice to the visual image signal.

Preferably, the reference information includes language translation information provided to the processing unit for converting the visual image signal to an output signal with a preset language.

Preferably, the output signal corresponds to an output image shown on a display unit.

According to the second aspect of the present invention, a electronic reading device is provided. The electronic reading device includes a capturing unit capturing a voice; and a processing unit converting the voice to a visual image signal based on specific information.

Preferably, the electronic reading device further includes a first storage unit storing the specific information; a display unit showing a visual image corresponding to the visual image signal; and a second storage unit storing at least one of the visual image signal and the voice.

Preferably, the display unit includes a bistable display

Preferably, the bistable display is one selected from a group consisting of an electrophoretic display, a cholesteric liquid crystal display and a quick-response liquid powder display.

Preferably, the visual image is one selected from a group consisting of a word image, a figure image, a symbol image and a combination thereof.

Preferably, the specific information includes at least one of speech recognition information and language translation information.

Preferably, the language translation information is provided to the processing unit for converting the visual image signal to an output signal with a preset language.

Preferably, the output signal corresponds to the visual image shown on the display unit.

Preferably, the visual image signal is one selected from a group consisting of a word signal, a figure signal, a symbol signal and a combination thereof.

Due to the feature of power saving, the electronic reading device of the present invention can be used the function of speech recognition continuously to make people with hearing impairment and normal people in a foreign country to know the contents of the ambient communications. In addition, because of the feature of easy reading, the device is suitable for prolonged use. Even if the device is used under hard light, the user can still use the device with speech recognition.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a block diagram schematically illustrating an embodiment of the present invention.

### DETAILED DESCRIPTION OF THE PREFERRED EMBODIMENT

The present invention will now be described more specifically by the following embodiments. However, it is to be noted that the following descriptions of preferred embodiments of this invention are presented herein for the purposes of illustration and description only; it is not intended to be exhaustive or to be limited to the precise form disclosed.

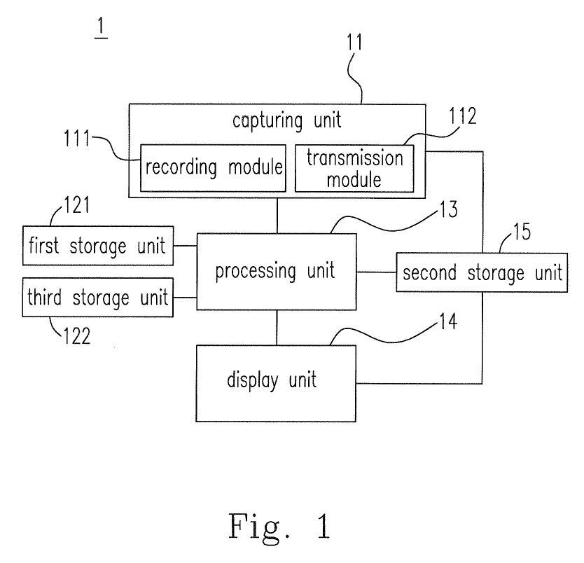

FIG. 1 is a block diagram illustrating an embodiment of a display apparatus according to the present invention. The display apparatus is preferably an electronic paper 1 to be regarded as an electronic reading device. The electronic paper 1 includes a capturing unit 11, a first storage unit 121, a third storage unit 122, a processing unit 13, a display unit 14 and a second storage unit 15.

The capturing unit 11 further includes a recording module 111 to receive the ambient voices and capture them for recording into the electronic paper 1. In addition, the capturing unit 11 can further includes a transmission module 112 which can receive the voice signals from other electronic devices through the transmission line and capture them for recording into the electronic paper 1.

The first reference information is preferably stored in the first storage unit 1 and the second reference information is preferably stored in the third storage unit 1, wherein the first reference information includes the speech recognition information and the second reference information includes the language translation information. The speech recognition information can be provided as a basis for comparing with the captured voices to convert the voices to the visual image signals. The language translation information can be provided as a basis for translating the word signals of the visual, image signals to show the output signals in other preset languages, wherein the output signals are one kind of the word signals. For example, the voices in English can be compared with the language translation information for translating into Chinese.

In the abovementioned embodiment, the third storage unit 112 can be merged with the first storage unit 121. That is to say, the speech recognition information and the language translation information can be stored together in the first storage unit 121.

The processing unit 13 is coupled with the capturing unit 11, the first storage unit 121 and the third, storage unit 122 is utilized to receive the captured voice from the capturing unit 11 and convert the voices to the visual image signals based on the first reference information. Generally, the word signals of the visual image signals are converted from the voice based on the speech recognition information stored in the first storage unit 121 by the processing unit 13 and then can be further converted to the other kinds of visual image signals thereby. In addition, the processing unit 13 can be utilized to determine according to the demands of the users whether the word signals should be further translated into other languages based on the language translation information stored in the third storage unit 122 for the users to use in the foreign country.

In the abovementioned embodiment, if the third storage unit 122 is merged with the first storage unit 121, the visual image signals are converted from the voices based on the speech recognition information stored in the first storage unit 121 by the processing unit 13 and the word signals of the image signals can be further translated into other languages based on the language translation information stored in the first storage unit 121 thereby.

The visual image signals can includes a word signal, a figure signal, a symbol signal and a combination thereof. The word signals are first generated through speech recognition by the processing unit 13 and then can be utilized to generate the figure signals, the symbol signals and the combination thereof. For example, after a word “computer” is recognized, an image signal corresponding to the word “computer” can be generated for showing a computer image on a display unit 14.

The display unit 14 is coupled with the processing unit 13 to receive the visual image signal to show a visual image, wherein the visual image is related to the visual image signal converted by the processing unit 13. In addition, the visual images can include a word image, a figure image, a symbol image, and a combination thereof respectively corresponding to the word signal, the figure signal, the symbol signal and the combination thereof. Furthermore, the output image corresponding to the output signal which is the word signal in other languages translated by the processing unit 13 can be shown on the display unit 14.

The display unit 14 is preferably a bistable display, such as an electrophoretic display, a cholesteric liquid crystal display, a quick-response liquid powder display, etc. Since the showing display generated in the power-on state can be hold and shown in the power-off state, the visual image can be generated in the power-on state and shown in the power-off state on the display unit 14 to be continuously seen by the users during the power-off time for power saving.

The second storage unit 15 can be coupled with the capturing unit 11, the processing unit 13 and the display unit 14. The captured voice can be stored in the second storage unit 15 to provide to the processing unit 13. When the captured voices can not be immediately processed by the processing unit 13, all of the voices can be stored in the second storage unit 15 and read therefrom to be processed by the processing unit 13. In addition, the visual image signals and the translated word signals can be stored in the second storage unit 15 to provide the user to read the stored contents again.

The electronic reading device of the present invention can be provided to show the contents of the communications in appropriate language on the electronic paper by using the speech recognition reference and the language translation reference. Due to the features of power saving and easy reading, the electronic reading device of the present invention can be suitable for prolonged use and be a convenient communication tool for people with hearing impairment and normal people in a foreign country. In fact, the invention should not be limited to the abovementioned using condition. On the condition that the speech recognition function is appropriate to be used, the electronic reading device of the present invention can be used for, power saving.

While the invention has been described in terms of what are presently considered to be the most practical and preferred embodiments, it is to be understood that the invention should not be limited to the disclosed embodiment. On the contrary, it is intended to cover numerous modifications and variations included within the spirit and scope of the appended claims which are to be accorded with the broadest interpretation so as to encompass all such modifications and variations. Therefore, the above description and illustration should not be taken as limiting the scope of the present invention which is defined by the appended claims.

What is claimed is:

1. An electronic reading device, comprising:
a capturing unit capturing a voice;
a first storage unit storing a reference information; and
a processing unit converting the voice to a visual image signal based on the reference information.

2. The electronic reading device as claimed in claim 1 further comprising:
a display unit showing a visual image corresponding to the visual image signal; and
a second storage unit storing at least one of the visual image signal and the voice.

3. The electronic reading device as claimed in claim 2, wherein the display unit comprises a bistable display.

4. The electronic reading device as claimed in claim 3, wherein the bistable display is one selected from a group consisting of an electrophoretic display, a cholesteric liquid crystal display and a quick-response liquid powder display.

5. The electronic reading device as claimed in claim 2, wherein the visual image is one selected from a group consisting of a word image, a figure image, a symbol image and a combination thereof.

6. The electronic reading device as claimed in claim 1, wherein the visual image signal is one selected from a group consisting of a word signal, a figure signal, a symbol signal and a combination thereof.

7. The electronic reading device as claimed in claim 1, wherein the reference information comprises a speech recognition information provided to the processing unit for converting the voice to the visual image signal.

8. The electronic reading device as claimed in claim 1, wherein the reference information comprises a language translation information provided to the processing unit for converting the visual image signal to an output signal with a preset language.

9. The electronic reading device as claimed in claim 8, wherein the output signal corresponds to an output image shown on a display unit.

10. An electronic reading device, comprising:
a capturing unit capturing a voice; and
a processing unit converting the voice to a visual image signal based on a specific information.

11. The electronic reading device as claimed in claim 10 further comprising:
a first storage unit storing the specific information;
a display unit showing a visual image corresponding to the visual image signal; and
a second storage unit storing at least one of the visual image signal and the voice.

12. The electronic reading device as claimed in claim 11, wherein the display unit comprises a bistable display.

13. The electronic reading device as claimed in claim 12, wherein the bistable display is one selected from a group consisting of an electrophoretic display, a cholesteric liquid crystal display and a quick-response liquid powder display.

14. The electronic reading device as claimed in claim 11, wherein the visual image is one selected from a group consisting of a word image, a figure image, a symbol image and a combination thereof.

15. The electronic reading device as claimed in claim 11, wherein the specific information comprises at least one of a speech recognition information and a language translation information.

16. The electronic reading device as claimed in claim 15, wherein the language translation information is provided to the processing unit for converting the visual image signal to an output signal with a preset language.

17. The electronic reading device as claimed in claim 16, wherein the output signal corresponds to the visual image shown on the display unit.

18. The electronic reading device as claimed in claim 10, wherein the visual image signal is one selected from a group consisting of a word signal, a figure signal, a symbol signal and a combination thereof.
